(19) United States
(12) Patent Application Publication
(10) Pub. No.: US 2012/0239873 A1
(43) Pub. Date: Sep. 20, 2012

(54) Memory access system and method for optimizing SDRAM bandwidth

(75) Inventors: Ming-Chuan Huang, Zhubei City (TW); Chia-Hao Lee, Tainan City (TW)

(73) Assignee: Sunplus Technology Co., Ltd., Hsinchu (TW)

(21) Appl. No.: 13/137,643

(22) Filed: Aug. 31, 2011

(30) Foreign Application Priority Data
Mar. 16, 2011 (TW) 100108955

(51) Int. Cl. G06F 12/00

(52) U.S. Cl. 711/105; 711/E12.001

(57) ABSTRACT

A memory access system for optimizing SDRAM bandwidth includes a memory command processor, and an SDRAM interface and protocol controller. The memory command processor is connected to a memory bus arbiter and data switch circuit for receiving memory access commands outputted by the memory bus arbiter and data switch circuit and converting the memory access commands into reordered SDRAM commands. The SDRAM interface and protocol controller is connected to the memory command processor for receiving and executing the reordered SDRAM commands based on protocol and timing of SDRAM. The memory command processor decodes the memory access commands into general SDRAM commands or alternative SDRAM commands. The memory access commands decoded into alternative SDRAM commands are generated by a specific bus master.

### CROSS REFERENCE TO RELATED APPLICATION

This application claims the benefits of the Taiwan Patent Application Serial Number 100108955, filed on Mar. 16, 2011, the subject matter of which is incorporated herein by reference.

### BACKGROUND OF THE INVENTION

1. Field of the Invention

The present invention relates to the technical field of memory accesses and, more particularly, to a memory access system and method for optimizing synchronous dynamic random access memory (SDRAM) bandwidth.

2. Description of Related Art

With the rapid development of computer systems, microcomputer systems, consumer electronics, and semiconductor technologies, source data synchronous communication interfaces are improved greatly. For example, the access speed of DDR, DDR-II, and DDR-III synchronous dynamic random access memory (SDRAM) is raised quickly, and the higher memory bandwidth is provided. The SDRAM access speed is increased from several MHz to Giga Hz in several years. The number of latency cycles in a non-active band memory access is gradually increased. For example, the number of latency cycles in a non-active band memory access is between three and five for an SDR SDRAM and between 12 and 15 for a DDR2 or a DDR3 SDRAM.

A computer system or a video processing system includes a plurality of system bus masters. Each of the system bus masters has a special function such as video decoding, video encoding, video playback, audio decoding, audio playback, DMA, CPU and the like. Since each of the system bus masters can perform a special function, the system bus masters can concurrently access the memory access areas at a different address in a different command format, so that the dynamic memory access commands generated by the system bus masters can be used to access one or more different dynamic memory banks. Since the system bus masters concurrently access a memory at a different address, it is hard to find an active page of a current memory access command as same as that of a previous one.

FIG. 1 is a block diagram of a typical SDRAM. FIG. 2 is a schematic diagram of accessing to different pages in typical double data rate (DDR) memory access commands, which reads A bank (BA0) of a memory twice, each Data-length of read-command is burst-8 (8 serial data out mode). At time T0, a memory controller outputs a precharge command PRE to the bank A of the memory. At time T3 after three clock cycles, the memory controller outputs an active command ACT to the bank A, and in this case the three-clock-cycle period is applied in accordance with tRP=3 defined in the DDR-SDRAM specification. At time T6 after three clock cycles again, the memory controller outputs a read command READ to the bank A, and in this case the three-clock-cycle period is applied in accordance with tRCD=3 defined in the DDR-SDRAM specification. At time T9 after three clock cycles (CL=3) again, the memory device (DDR-SDRAM) outputs corresponding data A1-A8 through the data bus. The second reading is operated at a different page of the SDRAM bank A, so the memory controller outputs a precharge command PRE to the memory at time T11 and an active command ACT at time T14. The active command cycles for a same memory bank are applied in accordance with tRC=11 defined in the memory specification. As shown in FIG. 2, at time T14, the memory device outputs corresponding data A9-A16 through the data bus, which requires a total of 24 clock cycles for successively reading 2 burst-8 read data. For an operation of non-optimized SDRAM access command, the SDRAM access losses the bandwidth of about 50%-70% Such a memory access wastes time and has no efficiency.

To overcome this, FIG. 3 is a schematic diagram of accessing to a DDR SDRAM in a conventional interleaving, which reads bank-A and bank-B (BA0, BA1) of a memory once, successively reading burst-8 data (burst 8) respectively. At time T0, a memory controller outputs a precharge command (PRE) to the bank A of the memory. At time T2, the memory controller outputs a precharge command (PRE) to the bank B of the memory. At time T3, the memory controller outputs an activate command (ACT) to the bank A. At time T5, the memory controller outputs an activate command (ACT) to the bank B. It is obvious that the active commands at time T3 and T5 are of different banks, and in this case the operation is not limited to tRC=11 defined in the DDR SDRAM specification. At time T6, the memory controller outputs a read command (Read) to the bank A. At time T9, the bank A of the DDR-SDRAM outputs corresponding data A1-A8 to the data bus. At time T13 after three clock cycles (CL=3), the DDR-SDRAM device outputs corresponding data B1-B8 to the data bus because at time T10 the memory controller outputs a read command (Read) to the bank B of the DDR-SDRAM device. In this case, for successively reading a burst-8 data respectively in the bank A and in the bank B, a total of 18 clock cycles are required. Thus, it can save a certain number of clock cycles as compared with FIG. 2. Generally, due to the memory access commands from different Bus-Masters, the memory command addresses are in different SDRAM-Bank and page location of the successive memory access commands. In this case, the probability of an interleaving access to different banks, as shown in FIG. 3, is low, particularly, in a complicated memory access system.

Another memory controller technology in the prior art uses a large memory access command queue to store many memory access commands and a complicated reordering algorithm to select a memory access command with the minimum latency or penalty cycles as a next access command to a SDRAM to thereby increase the SDRAM bandwidth utilization.

Another memory controller technology in the prior art uses multiple memory access command queues to select higher priority memory access commands to thereby reduce the number of latency cycles.

However, the two technologies cited above will relatively increase a large of read data latency for some memory read commands, resulting in unsatisfactory performance. At the same time, theses mechanisms and methods for accessing SDRAM in a complicated computing system cannot guarantee the SDRAM bandwidth utilization. The system will have a large memory and SDRAM bandwidth utilization depending on commands in command queue and application case. Thus, the cited technologies cannot ensure a high SDRAM bandwidth and the system performance.

Certain computing systems cannot use conventional technologies to improve the memory access performance. For example, a multi-media memory controller system has a complicated memory reference decoding algorithm (two dimension decoding for video image and a linear (sequence) memory access command) and almost all masters normally are accesses to different ranges of SDRAM addresses.

For an operation in such a system, the probability of finding an active page command (for next command) in current memory access commands in a command queue is low.

In the known patents, U.S. Pat. No. 6,629,220 granted to Dyer for a “Method and apparatus for dynamic arbitration between a first queue and a second queue based on a high priority transaction type” has disclosed a dynamic arbitration based on a high priority transaction type, which uses two queues to store different priority transaction types and adjusts the priorities according to a bandwidth limit.

U.S. Pat. No. 7,395,448 granted to Smith for a “Directly obtaining by application programs information usable in determining clock accuracy” has disclosed an information usable in determining the quality of time generated by a clock of a processing environment, which merges a plurality of short memory access commands into a long memory access command.

U.S. Pat. No. 6,564,304 granted to Van Hook, et al. for a “Memory processing system and method for accessing memory including reordering memory requests to reduce mode switching” has disclosed a memory processing system and method for accessing memory in a graphics processing system, which reorders memory access commands to thereby reduce the amount of mode switching (write command to read command or read command to write command).

U.S. Pat. No. 7,069,399 granted to Lin, et al. for a “Method and related apparatus for reordering access requests used to access main memory of a data processing system” has disclosed a method and related apparatus for reordering access requests used to access main memory of a data processing system, which reorders memory access commands based on latency cycles.

Finally, U.S. Pat. No. 7,281,110 granted to Cismas for a “Random access memory controller with out of order execution” has disclosed a memory controller for a multi-bank random access memory (RAM), which reorders commands of precharge PRE, active ACT, read READ, write WRITE for a SDRAM.

However, a system with such a reordering may relatively reduce the actually available SDRAM bandwidth due to the requirement for the maximum delay. Therefore, for a complete and complicated computing system, the cited command reordering cannot obtain the greatest SDRAM bandwidth and ensure the maximum system bandwidth.

Therefore, it is desirable to provide an improved memory access system and method for optimizing synchronous dynamic random access memory (SDRAM) bandwidth, so as to mitigate and/or obviate the aforementioned problems.

### SUMMARY OF THE INVENTION

The object of the present invention is to provide a memory access system for optimizing SDRAM bandwidth, which can increase the performance of a synchronous dynamic random access memory (SDRAM) access and avoid an interleaving access from losing the SDRAM bandwidth due to the over-small amount of data accesses.

In accordance with a feature of the invention, a memory access system for optimizing a synchronous dynamic random access memory (SDRAM) bandwidth is provided. The system includes a memory command processor and an SDRAM interface and protocol controller. The memory command processor is connected to a memory bus arbiter and data switch circuit in order to receive memory access commands outputted by the memory bus arbiter and data switch circuit and convert the memory access commands into reordered SDRAM commands. The SDRAM interface and protocol controller is connected to the memory command processor in order to receive and execute the reordered SDRAM commands based on a protocol and timing of the SDRAM. The memory command processor decodes the memory access commands into general or alternative SDRAM commands. The memory access commands decoded into alternative SDRAM commands are generated by a specific bus master.

In accordance with another feature of the invention, a memory access method for optimizing a synchronous dynamic random access memory (SDRAM) bandwidth is provided. The method is applied to a system on a chip (SoC) for executing SDRAM commands in a manner of optimized bandwidth. The method includes: (A) using a memory bus arbiter and data switch circuit to select and grant a next memory access command; (B) using the memory bus arbiter and data switch circuit to send the next memory access command to a memory access system (memory controller) for optimizing the SDRAM bandwidth; (C) using the memory access system to decode the next memory access command into SDRAM commands; (D) determining whether the memory access command is generated by a specific bus master; (E) storing the SDRAM commands in an alternative SDRAM command queue when it is determined in step (D) that the memory access command is generated by the specific bus master, and executing step (G); (F) storing the SDRAM commands in a general SDRAM command queue when it is determined in step (D) that the memory access command is not generated by the specific bus master, and executing step (G); and (G) extracting the SDRAM commands with a minimum penalty from the general SDRAM command queue or the alternative SDRAM command queue, and storing the SDRAM commands with the minimum penalty in a minimum penalty SDRAM command queue.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical DDRn SDRAM Device;

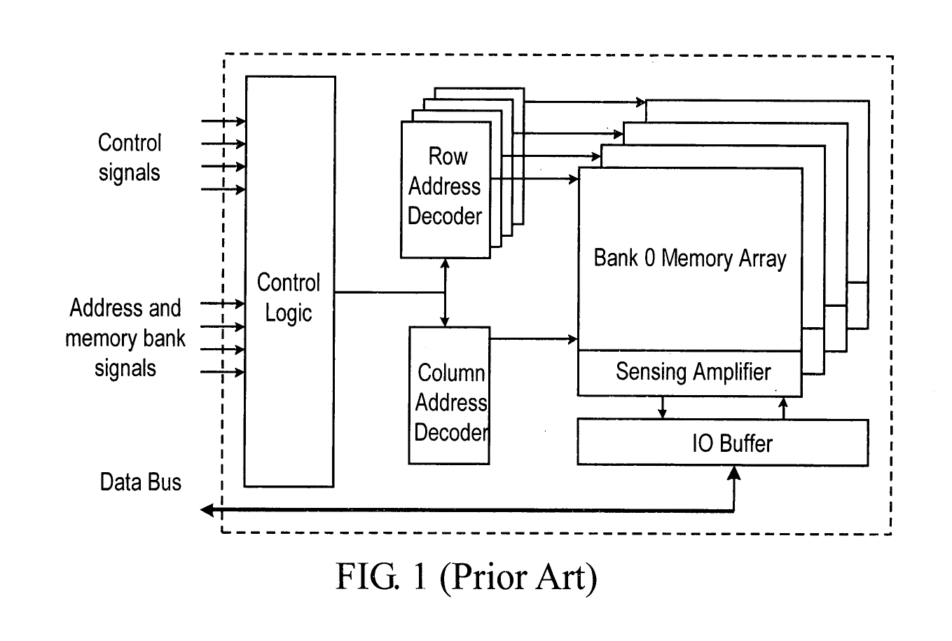

FIG. 2 is a schematic view of accessing to different pages in typical double data rate (DDR) SRAM memory access commands;

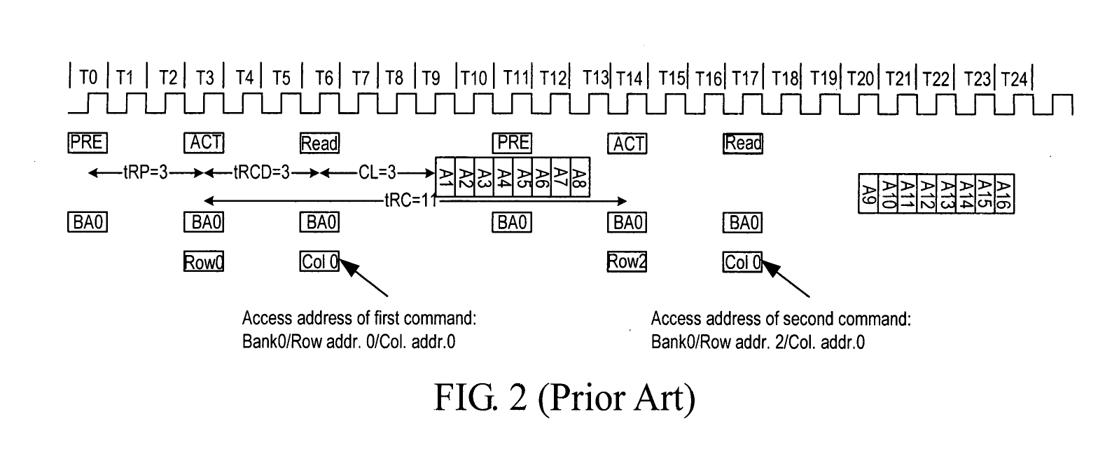

FIG. 3 is a schematic view of accessing to DDR SDRAM by bank interleaving technology;

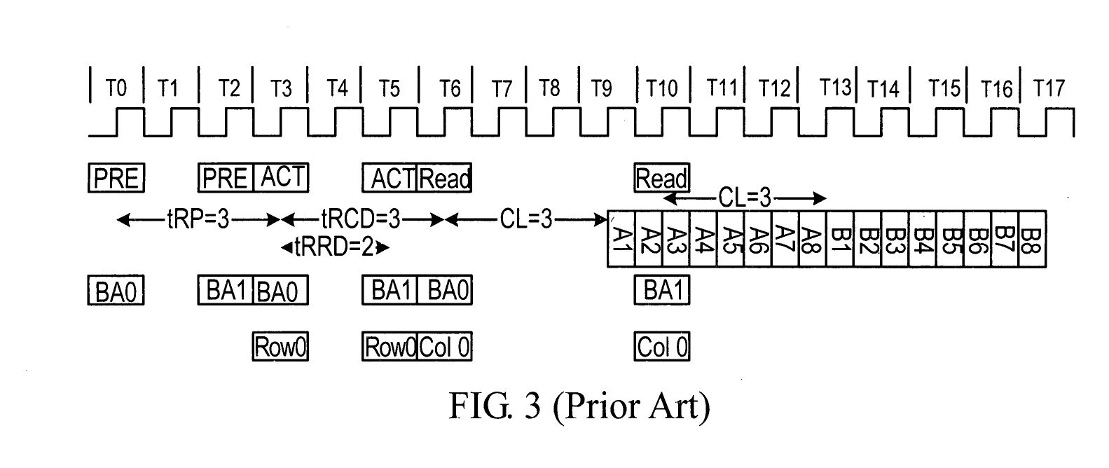

FIG. 4 is a block diagram of a memory access system for optimizing SDRAM bandwidth in accordance with an embodiment of the invention;

FIG. 5 is a schematic view of SDRAM commands reordered by using a prior synchronous dynamic random access command bandwidth optimization algorithm;

FIG. 6 is a schematic view of SDRAM commands reordered by a bandwidth optimization algorithm in accordance with an embodiment of the invention;

FIG. 7 is a flowchart of a memory access method for optimizing SDRAM bandwidth in accordance with an embodiment of the invention; and

FIG. 8 is a block diagram of a memory access system for optimizing SDRAM bandwidth in accordance with another embodiment of the invention.

### DETAILED DESCRIPTION OF THE PREFERRED EMBODIMENT

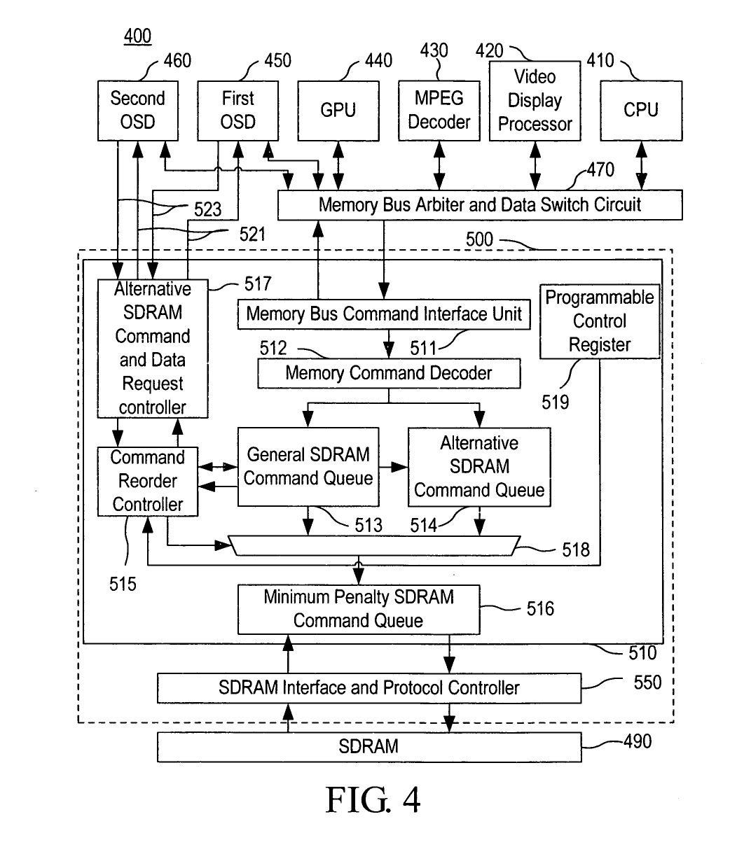

FIG. 4 is a block diagram of a memory access system 500 for optimizing an SDRAM bandwidth in accordance with an embodiment of the invention. As shown in FIG. 4, the system 500 is preferably used in a system on a chip (SoC) 400.

The SoC 400 includes a processor 410, a video display processor 420, an MPEG decoder 430, a graphic processing unit (GPU) 440, a first on screen display (OSD1) 450, a second on screen display (OSD2) 460, a memory bus arbiter and data switch circuit 470, a synchronous dynamic random access memory (SDRAM) 490, and the memory access system 500.

The processor 410, the video display processor 420, the MPEG decoder 430, the GPU 440, the first OSD 450, the second OSD 460 are each independent masters on a specific bus. The specific bus can be an AMBA, OCP, PCI bus system or other SoC on-chip bus/memory-bus system. Each of the masters generates memory access commands to the memory bus arbiter and data switch circuit 470. The memory bus arbiter and data switch circuit 470 arbitrates the memory access command and selects one of the memory access command to the next memory access command for the memory bus system. The next memory access command will be second to memory access system (500).

The memory access system 500 includes a memory command processor 510 and an SDRAM interface and protocol controller 550.

The memory command processor 510 is connected to the memory bus arbiter and data switch circuit 470 in order to receive a memory access command and data sent by the memory bus arbiter and data switch circuit 470 and convert the memory access command into a serial of SDRAM commands.

The SDRAM interface and protocol controller 550 is connected to the memory command processor 510 in order to receive and execute the reordered SDRAM command based on the SDRAM protocol and timing specification.

The memory command processor 510 decodes the memory access command into general SDRAM commands or alternative SDRAM commands.

The memory access command decoded into several alternative SDRAM commands are generated by one or more specific bus masters.

For convenience of description, in this embodiment, the specific bus masters are the first OSD 450 and the second OSD 460. In other embodiments, the other masters can be selected as the specific bus masters.

As shown in FIG. 4, the memory command processor 510 of the system 500 includes a memory bus command interface unit 511, a memory command decoder 512, a general SDRAM command queue 513, an alternative SDRAM command queue 514, a command reorder controller 515, a minimum penalty SDRAM command queue 516, an alternative SDRAM command and data request controller 517, an SDRAM command selection multiplexer 518, and a programmable control register 519.

The memory bus command interface unit 511 is connected to the memory bus arbiter and data switch circuit 470 in order to receive a memory access command sent by the memory bus arbiter and data switch circuit 470 and perform data receiving and sending of the memory access command.

The memory command decoder 512 is connected to the memory bus command interface unit 511 in order to decode the memory access command and generate multiple SDRAM commands. Each of the SDRAM commands can be a general SDRAM command or an alternative SDRAM command.

The general SDRAM command queue 513 is connected to the memory command decoder 512 in order to temporarily store the general SDRAM commands.

The alternative SDRAM command queue 514 is connected to the memory command decoder 512 in order to temporarily store the alternative SDRAM commands.

The command reorder controller 515 is connected to the general SDRAM command queue 513 and the alternative SDRAM command queue 514 in order to select the general SDRAM command or the alternative SDRAM command as a next reordered SDRAM command according to the bandwidth utility of an optimized SDRAM interface.

The multiplexer 518 is connected to the general SDRAM command queue 513, the alternative SDRAM command queue 514, and the command reorder controller 515 in order to output a command selected from the general SDRAM command queue 513 or the alternative SDRAM command queue 514 to the minimum penalty SDRAM command queue 516 as the next reordered SDRAM command.

The minimum penalty SDRAM command queue 516 is connected to the command reorder controller 515, the general SDRAM command queue 513, and the alternative SDRAM command queue 514 through the multiplexer 518 in order to temporarily store the next reordered SDRAM command.

The alternative SDRAM command and data request controller 517 is connected to the command reorder controller 515 and the specific bus masters 450, 460, and has a request new memory access command signal 521 to inform the specific bus masters 450, 460.

When the alternative SDRAM commands stored in the alternative SDRAM command queue 514 are used up or not enough in number, the alternative SDRAM command and data request controller 517 can use the request new memory access command signal 521 to inform the specific bus masters 450, 460, so as to generate and output a memory access command.

The alternative SDRAM command and data request controller 517 also has an urgent data request signal and data FIFO near full signal 523 outputted to the command reorder controller 515 for raising the priority of the alternative SDRAM command or keeping normal priority of the alternative SDRAM command.

In addition, when the specific bus masters 450, 460 urgently require data, the urgent data request signal and data FIFO near full signal 523 is used to inform the alternative SDRAM command and data request controller 517 and the command reorder controller 515, so that the command reorder controller 515 adjusts the priority of the alternative SDRAM command based on the urgent data request signal and data FIFO near signal 523. Accordingly, the specific bus masters 450, 460 can avoid the data starved condition.

The memory access commands generated by the specific bus masters 450, 460 are decoded by the memory command decoder 512 into an address range of specific memory banks of the SDRAM 490. For example, the memory access commands are decoded into the address range of the first and second memory banks or third and fourth memory banks of the SDRAM 490.

The programmable control register 519 is connected to the command reorder controller 515 in order to allow the command reorder controller 515 to adjust the priority of the general SDRAM command. The command reorder controller 515 combines and reorders all SDRAM commands generated by decoding the same memory access command, and outputs the reordered SDRAM commands to the minimum penalty SDRAM command queue.

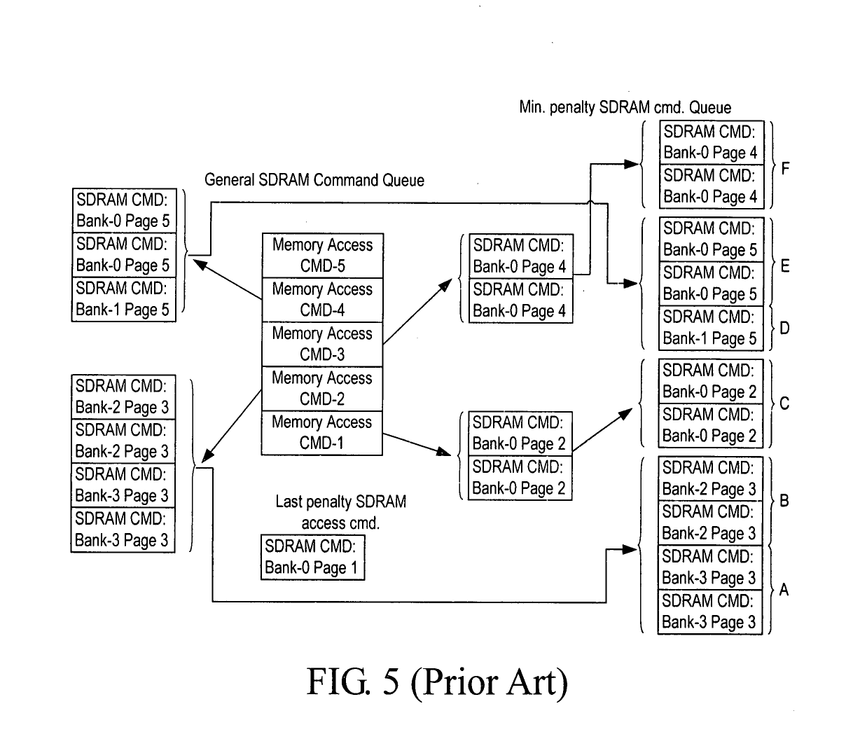

FIG. 5 is a schematic view illustrating the timing of typically performing SDRAM commands in order. As shown in FIG. 5, multiple SDRAM commands are generated by several memory access commands. For example, a memory access command CMD-1 can be decoded into two SDRAM commands for accessing to the Bank-0 Page-2 of the SDRAM, a memory access command CMD-2 can be decoded into two SDRAM commands for accessing to the Bank-2 Page-3 and two SDRAM commands for accessing Bank-3 Page-3 of the SDRAM, and so on.

Since the prior art does not have the alternative SDRAM command queue 514, a typical SDRAM controller with the command reordering function find or select a no-penalty or minimum-penalty SDRAM access command from the general SDRAM command queue for the next SDRAM access command. Typically, the reordered SDRAM commands are used to improve the utilization of SDRAM bandwidth. Each of the masters presents a different behavior and accesses different memory address range of whole system memory. For example, a video decoder and video processing master uses a 2-dimentional (block) mode to access a memory (X-directional start address, Y-directional start address, length in X direction, length in Y direction), a direction access memory (DMA) device uses a continuous address mode to access a memory, and a RISC/DSP processor mostly contains short data and a memory command type of accessing discontinuous addresses. Therefore, it is not guaranteed that a no-penalty SDRAM access command can be found in a typical SDRAM command queue for the SDRM controller with the SDRAM command reordering function.

The SDRM controller with the SDRAM command reordering function reorders the SDRAM commands of the general SDRAM command queue to thereby generate the minimum-penalty SDRAM commands, as shown in the right side of FIG. 5. The minimum penalty SDRAM commands shown in the right side of FIG. 5 are the best result that the typical reordering can obtain. As shown in FIG. 5, it seems to present an interleaving effect on accesses to the addresses of SDRAM bank-0 at C-command, SDRAM bank-1 at D-command, and SDRAM bank-0 at E-command. However, a penalty is still generated because the amount of data access (length) is too small at D-command. In addition, when accessing to the SDRAM bank-0 at E-command and F-command, the precharge command (PRE) and the active command (ACT) are required at F-command for accessing to different pages, so as to cause a large number of latency cycles.

The addresses of the SDRAM bank-0 at E-command and F-command are arranged together because the number of SDRAM access commands temporarily stored in the general SDRAM command queue is too small or can't find other commands at the moment. The typical solution is to enlarge the storage capacity of the general command queue so as to temporarily store a large number of memory access commands, which causes the system to generate a large number of latency cycles of memory access command, resulting in that the time of issuing a memory access command to obtaining the data is relatively increased. Therefore, the storage capacity of the general command queue in this case is limited, and a certain amount of SDRAM bandwidth is lost and to reduce the system performance, even the optimal reordering is applied to the SDRAM commands.

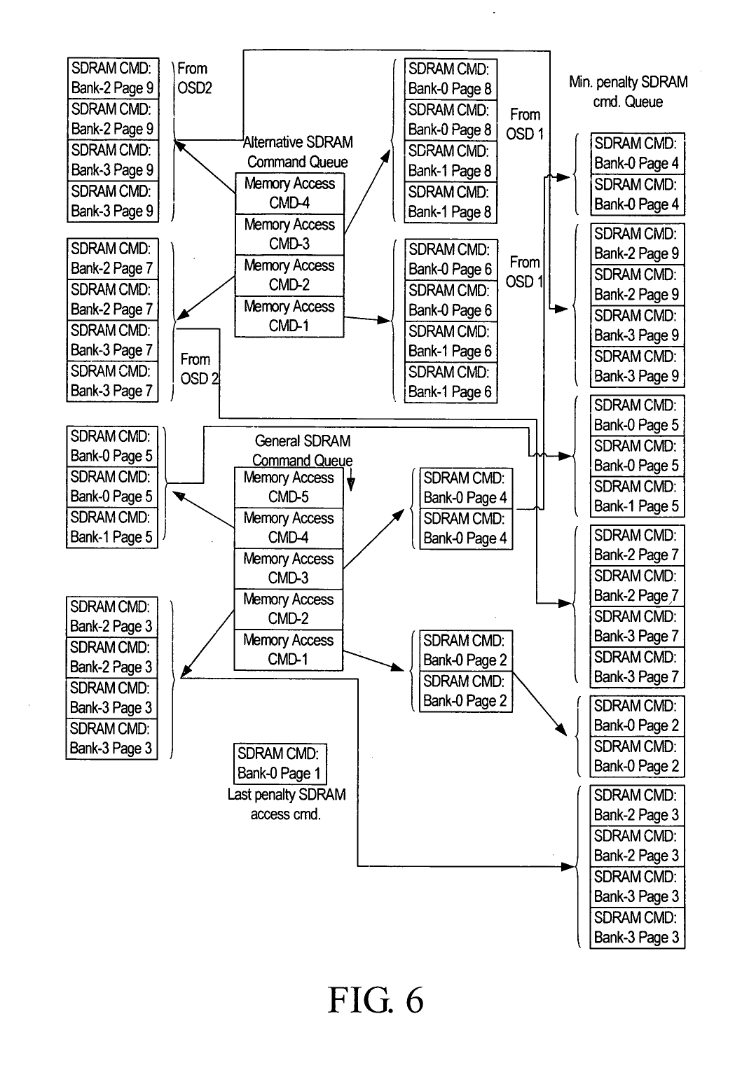

FIG. 6 is a schematic view of SDRAM commands when the alternative SDRAM command queue 514 is used in accordance with an embodiment of the invention. The design of the alternative SDRAM command queue 514 in the invention is for storing memory access commands periodically sent by certain bus masters. The SDRAM address range corresponding to the memory access commands of the masters can be predetermined to meet with the optimized SDRAM command interleaving access algorithm. As shown in FIG. 6, a series of memory access commands exist in the alternative SDRAM command queue 514.

In this case, the bus masters are the first OSD 450 (OSD1) and the second OSD 460 (OSD2). The memory access commands corresponding to the first OSD 450 are in the memory bank 0 (Bank-0) and 1 (Bank-1). Namely, the memory access commands corresponding to the first OSD 450 are decoded so as to access addresses of memory banks Bank-0 and Bank-1. Similarly, memory banks 2 (Bank-2) and 3 (Bank-3) of the SDRAM correspond to the memory access commands of the second OSD 460. Thus, the alternative SDRAM command queue 514 contains the SDRAM commands of all SDRAM banks, and the command reorder controller 515 can use the SDRAM commands stored in the general SDRAM command queue 513 or the alternative SDRAM command queue 514 to generate a no-penalty SDRAM command sequence.

The right side of FIG. 6 is an optimized SDRAM command sequence. As shown in FIG. 6, different from FIG. 5 at D-command, the SDRAM command sequence has no SDRAM bandwidth loss caused by the bank interleave with small data length case (FIG. 5 SDRAM D-command) And the new architecture, the SDRAM command sequence has no SDRAM bandwidth loss caused by SDRAM command bank interleave failure case.

As shown in FIG. 4, the dedicated interface in the memory access system 500 is provided to the alternative SDRAM command queue 514. The alternative SDRAM command and data request controller 517 is used to request a new memory access command. When there are no enough access commands to perform a no-penalty reordering process, the alternative SDRAM command and data request controller 517 uses the request new memory access memory signal 521 to inform the specific bus masters 450, 460. For example, when alternative SDRAM command queue (514) doesn't have or only have one SDRAM Bank-2 or Bank-3 command, the alternative SDRAM command and data request controller 517 uses the request new memory access memory signal 521 to inform the second OSD (OSD2) 460 to send a new memory access command.

As shown in FIG. 4, when the specific bus masters 450, 460 urgently require data, the urgent data request signal and data FIFO near full signal 523 is applied for informing the alternative SDRAM command and data request controller 517 and the command reorder controller 515. In this case, the command reorder controller 515 is based on the urgent data request signal and data FIFO near full signal 523 to set highest priority of the alternative SDRAM command or exclude the alternative SDRAM command temporarily, respectively.

In this embodiment, the memory access commands stored in the general SDRAM command queue 513 have a higher priority than those stored in the alternative SDRAM command queue 514 in normal. The command reorder controller 515 uses a timer (not shown) to change the priority to thereby guarantee the service time and bandwidths of certain desired bus masters.

When the specific bus masters 450, 460 generate the urgent data request signal, the command reorder controller 515 assigns a higher priority to the memory access commands stored in the alternative SDRAM command queue 514 to thereby meet with the data requirement of memory access commands of the bus masters 450, 460.

When the space of data read buffer of the specific bus masters is near full, an FIFO data near full signal is used to inform the command reorder controller 515, and in this case the command reorder controller 515 can only select the memory access commands stored in the general SDRAM command queue 513.

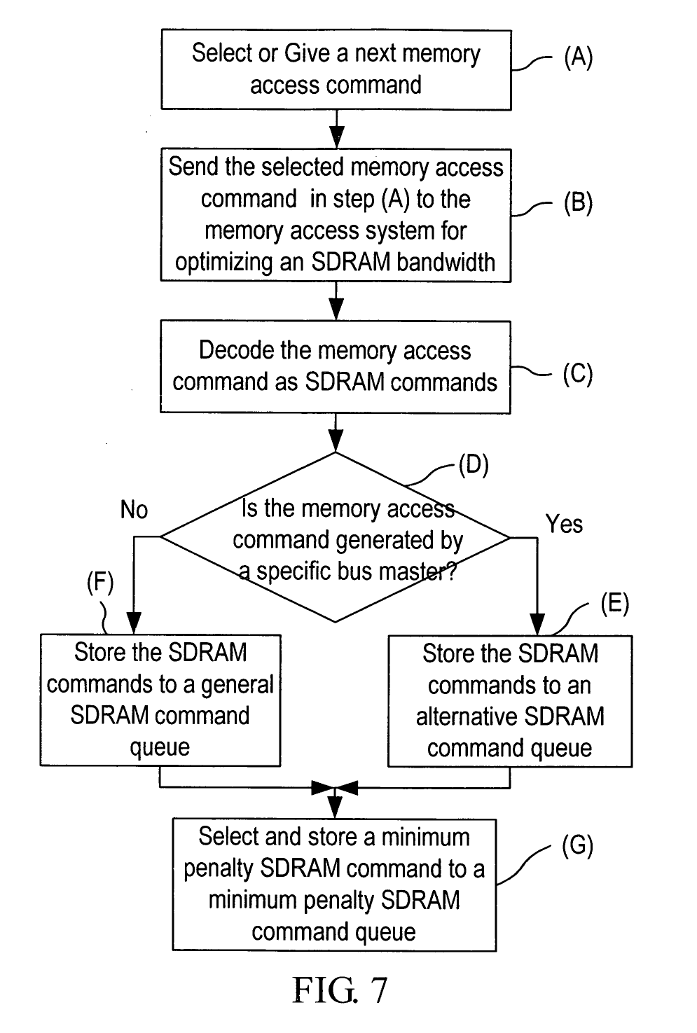

FIG. 7 is a flowchart of a memory access method for optimizing an SDRAM bandwidth in accordance with an embodiment of the invention. In FIG. 7, the method is implemented in a system on a chip (SoC) 400 in order to access data of the SDRAM 490 in an optimized SDRAM bandwidth algorithm and configuration.

First, in step (A), the memory bus arbiter and data switch circuit 470 selects or grants a next memory access command.

In step (B), the memory bus arbiter and data switch circuit 470 sends the memory access command selected in step (A) to the memory access system 500.

In step (C), the memory access system 500 decodes the memory access command to SDRAM commands.

In step (D), it is determined whether the memory access command is generated by a specific bus master or not. If yes, the SDRAM commands are stored in the alternative SDRAM command queue 514 in step (E); otherwise, the SDRAM commands are stored to the general SDRAM command queue 513 in step (F). The alternative SDRAM command correspondingly generated by the specific bus master is decoded to access certain specific or desired banks of the SDRAM (SDRAM banks).

In step (G), a no-penalty or minimum penalty SDRAM command is selected from the general SDRAM queue 513 or the alternative SDRAM queue 514, and stored to the minimum penalty SDRAM command queue 516.

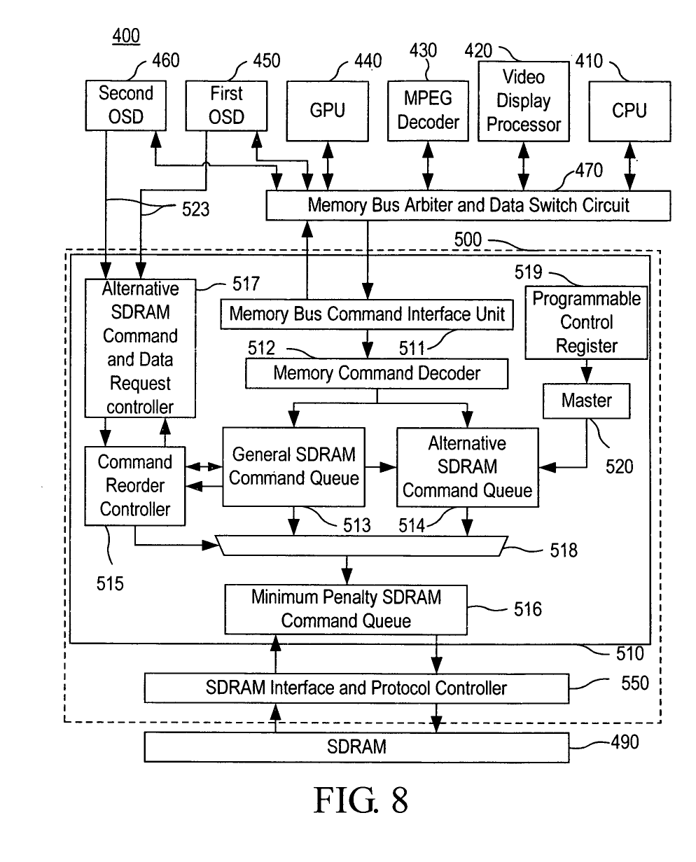

FIG. 8 is a schematic diagram of a memory access system 500 for optimizing SDRAM bandwidth in accordance with another embodiment of the invention, which is similar to that of FIG. 4 except that an access memory master 520 is added in FIG. 8. The access memory master 520 can be an OSD or direct memory access (DMA) controller. The access memory master 520 includes a programmable controller (not shown) to set corresponding memory access parameters, such as the start address of memory for a data read, access length, the start address of memory for a data write, and the average bandwidth request of the master.

As cited, the invention provides a memory access system and method for optimizing an SDRAM bandwidth, which is a new memory access configuration and process. The invention uses the alternative SDRAM command queue 514 to temporarily store the memory access command generated by a specific bus master. The memory access command generated by the bus master is decoded into SDRAM commands for accessing specific SDRAM banks. Accordingly, the command reorder controller 515 is based on a maximum utility of SDRAM interface to select a general SDRAM command from the general SDRAM command queue 513 or an alternative SDRAM command from the alternative SDRAM command queue 514 as the reordered SDRAM command. Since the memory access command generated by the bus master is decoded into SDRAM commands to access specific SDRAM banks, the command reorder controller 515 can implement a no-penalty interleaving access of the SDRAM commands to thereby optimize the performance of an SDRAM access. Also, it is able to effectively eliminate the problem of bandwidth loss caused by the amount of data accesses of some SDRAM commands being too short in an SDRAM interleaving access.

Although the present invention has been explained in relation to its preferred embodiment, it is to be understood that many other possible modifications and variations can be made without departing from the spirit and scope of the invention as hereinafter claimed.

What is claimed is:

1. A memory access system for optimizing synchronous dynamic random access memory (SDRAM) bandwidth, comprising:
a memory command processor connected to a memory bus arbiter and data switch circuit for receiving memory access commands outputted by the memory bus arbiter and data switch circuit and converting the memory access commands into reordered SDRAM commands; and
an SDRAM interface and protocol controller connected to the memory command processor for receiving and executing the reordered SDRAM commands based on protocol and timing of SDRAM;
wherein the memory command processor decodes the memory access commands into general SDRAM commands or alternative SDRAM commands, and the memory access commands decoded into alternative SDRAM commands are generated by a specific bus master.

2. The memory access system as claimed in claim 1, wherein the memory command processor comprises:
a memory bus command interface unit connected to the memory bus arbiter and data switch circuit for receiving the memory access commands sent by the memory bus arbiter and data switch circuit and performing data receiving and sending;
a memory command decoder connected to the memory bus command interface unit for decoding the memory access commands and generating SDRAM commands, wherein the SDRAM commands are general or alternative SDRAM commands;
a general SDRAM command queue connected to the memory command decoder for temporarily storing the general SDRAM commands;
an alternative SDRAM command queue connected to the memory command decoder for temporarily storing the alternative SDRAM commands;
a command reorder controller connected to the general SDRAM command queue and the alternative SDRAM command queue for selecting the general or the alternative SDRAM commands as a next reordered SDRAM command according to a maximum utilization of SDRAM data bandwidth algorithm; and
a minimum penalty SDRAM command queue connected to the command reorder controller, the general SDRAM command queue, and the alternative SDRAM command queue for temporarily storing the next reordered SDRAM command.

3. The memory access system as claimed in claim 2, wherein the memory command processor comprises an “Alternative SDRAM command and data request controller” which is connected to the command reorder controller and has a request new memory access command signal to inform the specific bus masters.

4. The memory access system as claimed in claim 3, wherein the alternative SDRAM command and data request controller has an urgent data request signal and data first-in-first-out (FIFO) near full signal, and the command reorder controller adjusts a priority of the alternative SDRAM command based on the urgent data request signal and data FIFO near full signal.

5. The memory access system as claimed in claim 4, wherein the memory command decoder decodes the memory access command generated by the specific bus master into a specific range of single bank address of the SDRAM.

6. The memory access system as claimed in claim 4, wherein the memory command decoder decodes the memory access command generated by the specific bus master into a specific range of two banks address of the SDRAM.

7. The memory access system as claimed in claim 4, wherein the memory command decoder decodes the memory access command generated by the specific bus master into a specific range of four banks address of the SDRAM.

8. The memory access system as claimed in claim 4, wherein the memory command processor comprises a programmable control register connected to the command reorder controller for allowing the command reorder controller to adjust a priority of the general SDRAM command based on settings of the programmable control register.

9. The memory access system as claimed in claim 4, wherein the command reorder controller combines and reorders all SDRAM commands generated by decoding a same memory access command, and outputs the reordered SDRAM commands to the minimum penalty SDRAM command queue.

10. A memory access method for optimizing synchronous dynamic random access memory (SDRAM) bandwidth, which is applied on a system on a chip (SoC) for executing SDRAM commands in a manner of optimized bandwidth, the method comprising the steps of
(A) using a memory bus arbiter and data switch circuit to select or grant a next memory access command;
(B) using the memory bus arbiter and data switch circuit to send the next memory access command to a memory access system for optimizing the SDRAM bandwidth;
(C) using the memory access system to decode the next memory access command into SDRAM commands;
(D) determining whether the memory access command is generated by a specific bus master;
(E) storing the SDRAM commands in an alternative SDRAM command queue when it is determined in step (D) that the memory access command is generated by the specific bus master, and executing step (G);
(F) storing the SDRAM commands in a general SDRAM command queue when it is determined in step (D) that the memory access command is not generated by the specific bus master, and executing step (G); and
(G) extracting the SDRAM commands with a minimum penalty from the general SDRAM command queue or the alternative SDRAM command queue, and storing the SDRAM command with the minimum penalty in a minimum penalty SDRAM command queue.

11. The memory access method as claimed in claim 10, wherein the memory access command generated by the specific bus master is provided for accessing to specific banks of the SDRAM.
